(19) United States
(12) Patent Application Publication
(10) Pub. No.: US 2022/0228705 A1
(43) Pub. Date: Jul. 21, 2022

(54) Accessory Component Mounting Structure for Canister

(71) Applicant: AISAN KOGYO KABUSHIKI KAISHA, Obu-shi, Aichi-ken (JP)

(72) Inventors: Mariko KAWASE, Funabashi-shi, Chiba-ken (JP); Naohito BUSEKI, Obu-shi, Aichi-ken (JP); Yoshihiko HONDA, Obu-shi, Aichi-ken (JP)

(73) Assignee: AISAN KOGYO KABUSHIKI KAISHA, Obu-shi, Aichi-ken (JP)

(21) Appl. No.: 17/615,577

(22) PCT Filed: Jun. 19, 2020
(86) PCT No.: PCT/JP2020/024073

§ 371 Date: Nov. 30, 2021

(30) Foreign Application Priority Data
Jun. 24, 2019 (JP) 2019-116346

(51) Int. Cl. F16M 13/02

(52) U.S. Cl. CPC F16M 13/02

(57) ABSTRACT

An accessory component mounting structure includes a tubular pump mounting portion provided in a canister and a purge pump having a motor unit that generates heat. The purge pump is inserted into the internal space of the pump mounting portion and is mounted by snap-fitting. A gap passage extending from an opening side of the pump mounting portion to the rear side thereof is provided between the pump mounting portion and the purge pump. A first communication hole in fluid communication with the gap passage and the outside is provided in the pump mounting portion.

### CROSS-REFERENCE TO RELATED APPLICATIONS

This application is a 35 U.S.C. § 371 US National Stage Entry application claiming priority to PCT Patent Application No. PCT/JP2020/024073 filed Jun. 19, 2020, which claims priority to Japanese Patent Application No. 2019-116346, filed Jun. 24, 2019, each of which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to an accessory component mounting structure for a canister.

### BACKGROUND

Conventionally, an accessory component mounting structure may be provided for a canister, for example, as described in Japanese Laid-Open Patent Publication No. 2010-106712. The mounting structure includes a cylindrical component mounting portion provided in the canister and an accessory component having a heat-generating portion that generates heat. The accessory component inserted into the internal space of the component mounting portion is mounted by snap-fitting. The accessory component is provided with a projection that is in contact with the side wall of the component mounting portion to suppress rattling. The accessory component has a built-in motor that generates heat, which may accumulate in the internal space of the component mounting portion of the canister.

### SUMMARY

Embodiments described herein are directed to devices and methods to suppress heat generated by the heat-generating portion of the accessory component from accumulating in the internal space of the component mounting portion of the canister.

According to one aspect of the present disclosure, an accessory component mounting structure for a canister includes a tubular component mounting portion provided in the canister and an accessory component having a heat-generating portion. The accessory component is inserted into the internal space of the component mounting portion and is mounted by snap-fitting. A gap passage communicating an opening side of the component mounting portion with the rear side thereof is formed between the component mounting portion and the accessory component. A communication hole communicating the gap passage to the outside is formed in the component mounting portion.

According to the above aspect, the gap passage communicating with the outside via the communication hole is formed between the component mounting portion and the accessory component. Therefore, air may pass through the gap passage to aid in dissipating heat accumulated in the gap passage. As a result, it is possible to suppress the heat generated by the heat-generating portion of the accessory component from accumulating in the internal space of the component mounting portion of the canister.

### BRIEF DESCRIPTION OF DRAWINGS

FIG. 1 is a perspective view of a canister and a purge pump mounted to the canister according to an embodiment.

FIG. 2 is an enlarged front view of the purge pump mounted to the canister.

FIG. 3 is a cross-sectional view of the canister and purge pump of FIG. 1 taken along line III-III of FIG. 2.

FIG. 4 is a cross-sectional view of the canister and purge pump of HG, 1 taken along line IV-IV of FIG. 2.

FIG. 5 is a perspective view of a pump mounting portion of the canister of FIG.

FIG. 6 is an exploded view of the canister and the purge pump of FIG. 1.

FIG. 7 is a front view of the purge pump of FIG. 1.

FIG. 8 is a left side view of the purge pump of FIG. 1.

FIG. 9 is a right side view of the purge pump of FIG. 1.

FIG. 10 is a plan view of the purge pump of FIG. 1.

FIG. 11 is a rear view of the purge pump of FIG. 1.

FIG. 12 is a bottom view of the purge pump of FIG. 1.

FIG. 13 is a front view of the pump mounting portion of the canister of FIG. 1.

FIG. 14 is a cross-sectional view of the pump mounting portion of the canister of FIG. 1 taken along line XIV-XIV of FIG. 13,

FIG. 15 is a cross-sectional view of the pump mounting portion of the canister of FIG. 1 taken along line XV-XV of FIG. 13.

### DETAILED DESCRIPTION

Hereinafter, an embodiment of the present disclosure will be described with reference to the figures. In the present embodiment, a structure for mounting a purge pump as an accessory component to a canister will be described.

In a vehicle, such as an automobile, a canister filled with an adsorbent for adsorbing and desorbing fuel vapor is provided to prevent the fuel vapor generated in the fuel tank from being discharged into the atmosphere. The canister allows the adsorbent to adsorb the fuel vapor generated while the internal combustion engine (engine) is stopped. When the engine is driven, the fuel vapor is desorbed (purged) from the adsorbent by utilizing the intake negative pressure of the engine, and the desorbed fuel vapor is communicated to and combusted by the engine.

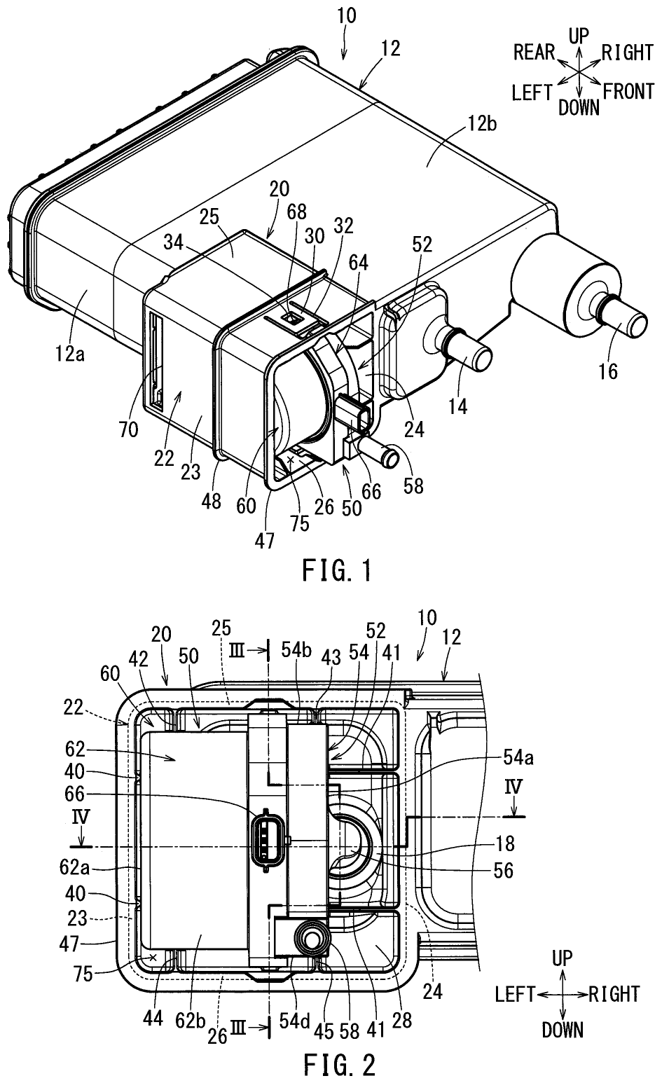

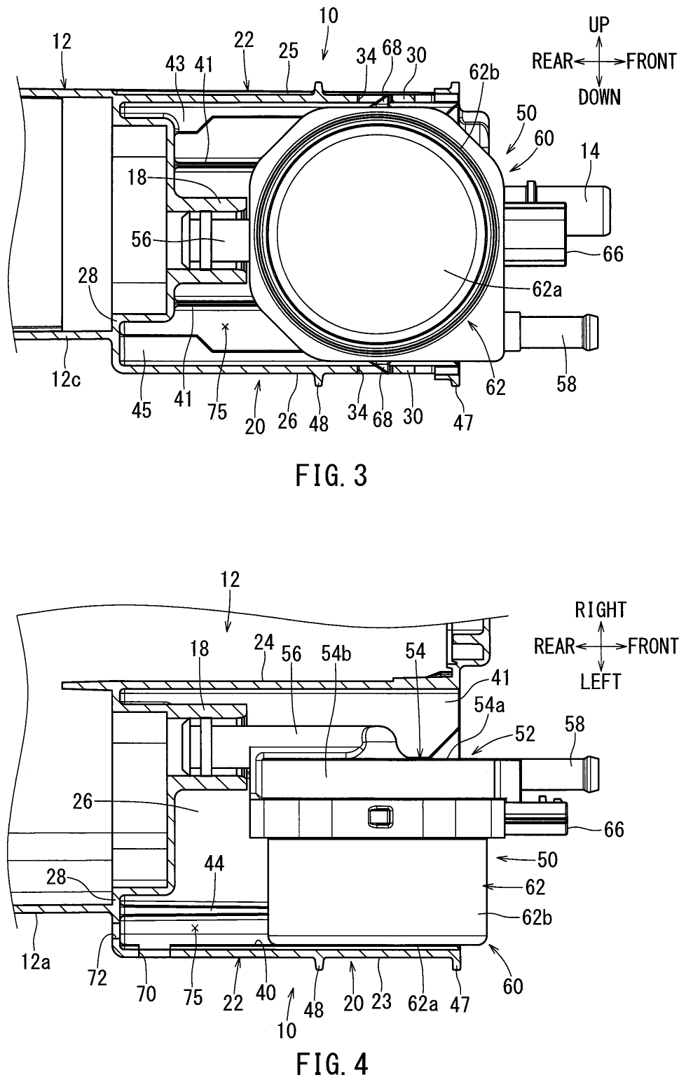

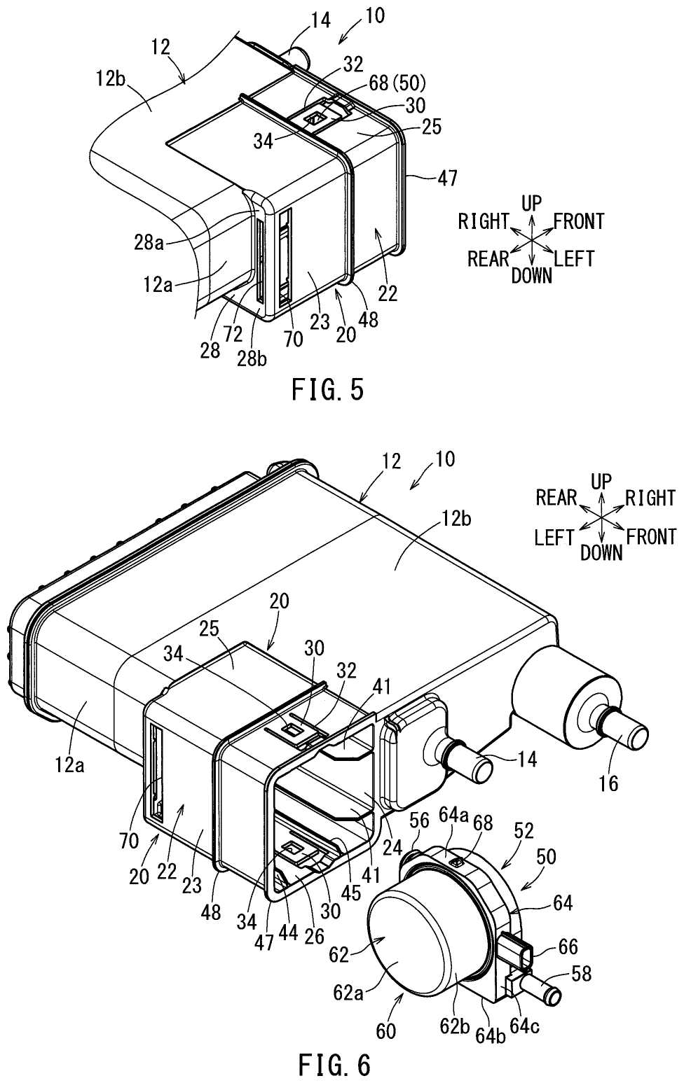

FIG. 1 is a perspective view of an embodiment of a canister 10 to which a purge pump 50 is mounted. FIG. 2 is a front view of the purge pump mounted to the canister. FIG. 3 is a cross-sectional view taken along line III-III of FIG. 2. FIG. 4 is a cross-sectional view taken along line IV-IV of FIG. 2. FIG. 5 is a perspective view of a pump mounting portion of the canister. Directions are discussed with reference to the arrows in each figure. In the present embodiment, the up-down direction corresponds to the up-down direction of the vehicle. The front-rear direction corresponds to the front-rear direction of the vehicle. The arrangement direction of the canister may be changed as appropriate.

As shown in FIG. 1, canister 10 includes an outer canister case 12 formed in a substantially cuboid shape with a relatively low height (in the up-down direction) as compared to its length and width in the front-rear and left-right directions, respectively. The canister case 12 is hollow and made of resin. An adsorbent configured to adsorb and desorb fuel vapor is provided in the internal space of the canister case 12. For example, granular activated carbon may be used as the adsorbent. The granular activated carbon may be, for example, crushed activated carbon (crushed charcoal) and/or granulated charcoal. Powdered activated carbon may be made into a granular form using a binder, thereby forming the granular activated carbon.

At the center of the front side of the canister case 12, a tank port 14 projects forward and is in fluid communication with the internal space of the canister case 12. At the right end of the front side of the canister case 12, an atmospheric port 16 projects forward and is in fluid communication with the internal space of the canister case 12. A fuel vapor passage connected to the fuel tank is connected to the tank port 14. An atmospheric passage opened to the atmosphere is connected to the atmospheric port 16.

A pump mounting portion 20, which has a tubular shape and an opening in its front surface, is formed at a front portion on the left side of the canister case 12. A purge pump 50 is received in the pump mounting portion 20 (see FIG. 1 to FIG. 4). As shown in FIG. 4, the purge pump 50 includes a suction port 56 and a discharge port 58. In the internal space of the pump mounting portion 20, a purge port 18 in fluid communication with the internal space of the canister case 12 project forwards. The suction port 56 of the purge pump 50 is connected to the purge port 18. The discharge port 58 of the purge pump 50 is connected to a purge passage in fluid communication with the intake passage of the engine. The pump mounting portion 20 and the purge pump 50 will be described in more detail below.

While the engine is stopped, fuel vapor in the fuel tank is guided, via the tank port 14, to the internal space of the canister 10. The fuel vapor is then adsorbed by the adsorbent. During the operation of the engine, the fuel vapor is desorbed from the adsorbent via the air flowing into the internal space of the canister 10 from the atmospheric port 16. Then, the fuel vapor is forcibly purged to the intake passage of the engine by the purge pump 50.

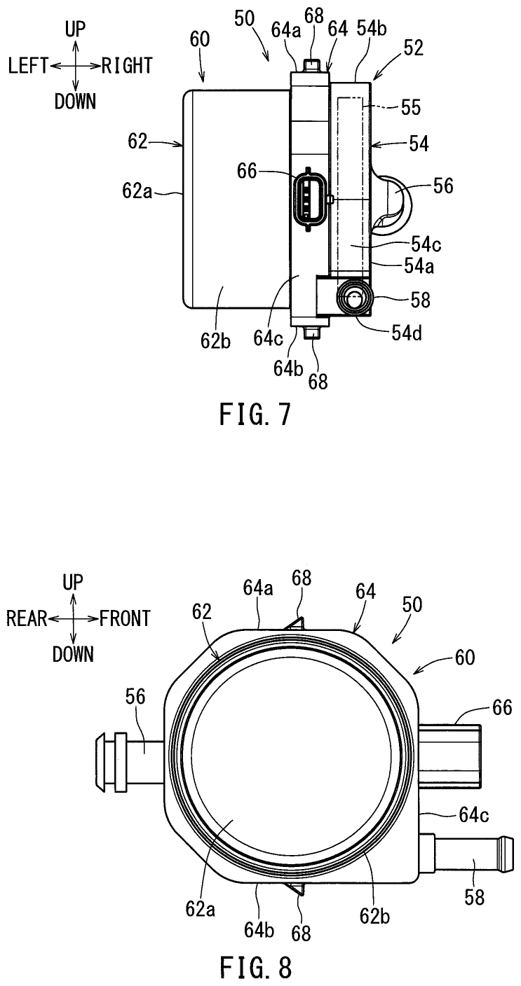

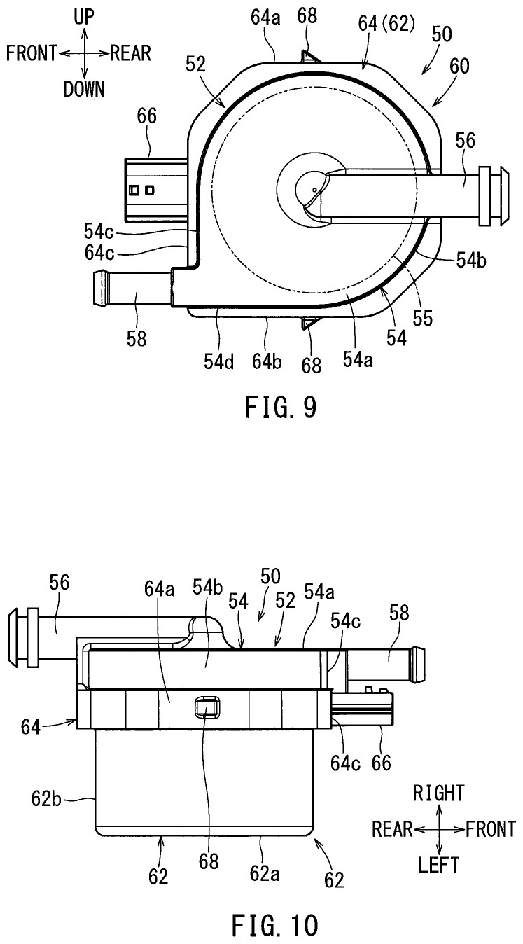

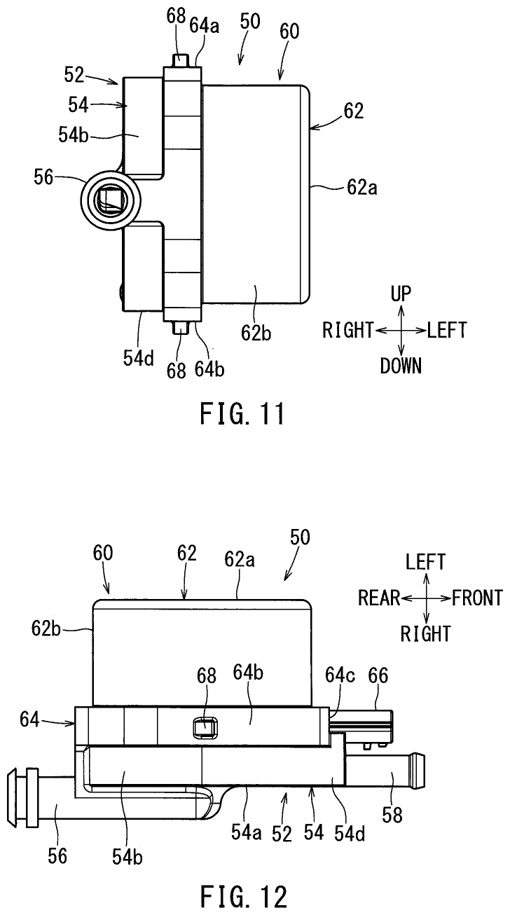

FIG. 6 is an exploded view of the canister 10 and the purge pump 50. FIG. 7 is a front view, FIG. 8 is a left side view, FIG. 9 is a right side view, FIG. 10 is a plan view, FIG. 11 is a rear view, and FIG. 12 is a bottom view of the purge pump 50. As shown in FIG. 6, the purge pump 50 may include a pump unit 52 and a motor unit 60. The motor unit 60 drive the pump unit 52.

The motor unit 60 includes an electric motor. The motor unit 60 generates heat due to operation of the electric motor. Accordingly, the motor unit 60 may also be referred to herein as a “heat-generating portion.” The motor unit 60 includes a substantially cylindrical outer motor housing 62. The motor housing 62 includes a left end surface 62a and an outer peripheral surface 62b.

A flange 64 extends outward from the motor housing 62 and is positioned at one end (e.g., the right end) in the axial direction of the motor housing 62. As shown in FIG. 8, the flange 64 has a shape similar to an octagon in a side view. A lower surface 64b and a front surface 64c of the flange 64 g intersect and are oriented perpendicular to each other. The flange 64 may have a substantially heptagon shape. The flange 64 has an upper surface 64a and the lower surface 64b that are oriented parallel to each other. An electric connector 66 projects forward from an upper end of a front surface 64c (see FIG. 10). The electric connector 66 connects to an external connector for supplying power to the motor unit 60.

Engagement projections 68 extend up-and-down symmetrically on the upper surface 64a and the lower surface 64b of the flange 64 (see FIGS. 6, 7, 9 and 10). Each engagement projection 68 has a right-angled triangular prism shape. Each engagement projection 68 has a slope facing obliquely rearward and extending in the left-right direction.

As shown in FIG. 7, the pump unit 52 includes a pump housing 54 with a short cylindrical shape. The pump unit 52 also includes an impeller 55, which is accommodated in the internal space of the pump housing 54 and rotatable about its central axis (see FIG. 9). The pump housing 54 is concentrically disposed on the right side of the flange 64 of the motor unit 60. The pump housing 54 has an outer diameter larger than the outer diameter of the motor housing 62 of the motor unit 60 and smaller than the outer diameter of the flange 64. The pump housing 54 has a right end surface 54a and an outer peripheral surface 54b.

As shown in FIG. 9, a front surface 54c and a lower surface 54d, which are oriented perpendicular to each other, are formed at the front lower corner of the outer peripheral surface 54b of the pump housing 54. The front surface 54c extends tangentially downward from the front end of the outer peripheral surface 54b. The lower surface 54d extends tangentially forward from the lower end of the outer peripheral surface 54b.

The suction port 56, which has a cylindrical shape and projects rearward, is provided at the right end surface 54a of the pump housing 54, so as to extend rearward from its axial center (see FIGS. 10 to 12). The discharge port 58, which has a cylindrical shape and extends forward, is provided at the lower end of the front surface 54c (see FIG. 7). The suction port 56 and the discharge port 58 are in fluid communication with the internal space of the pump housing 54. The impeller 55 is connected to an output shaft provided in the motor unit 60.

When power is supplied to the motor unit 60 of the purge pump 50, the motor unit 60 is driven, thereby rotating the impeller 55 of the pump unit 52. As a result, the purge gas in the canister 10 is sucked through the suction port 56 of the pump unit 52 and pressurized, and then discharged from the discharge port 58. The purge gas discharged from the discharge port 58 is pumped to the intake passage of the engine via the purge passage.

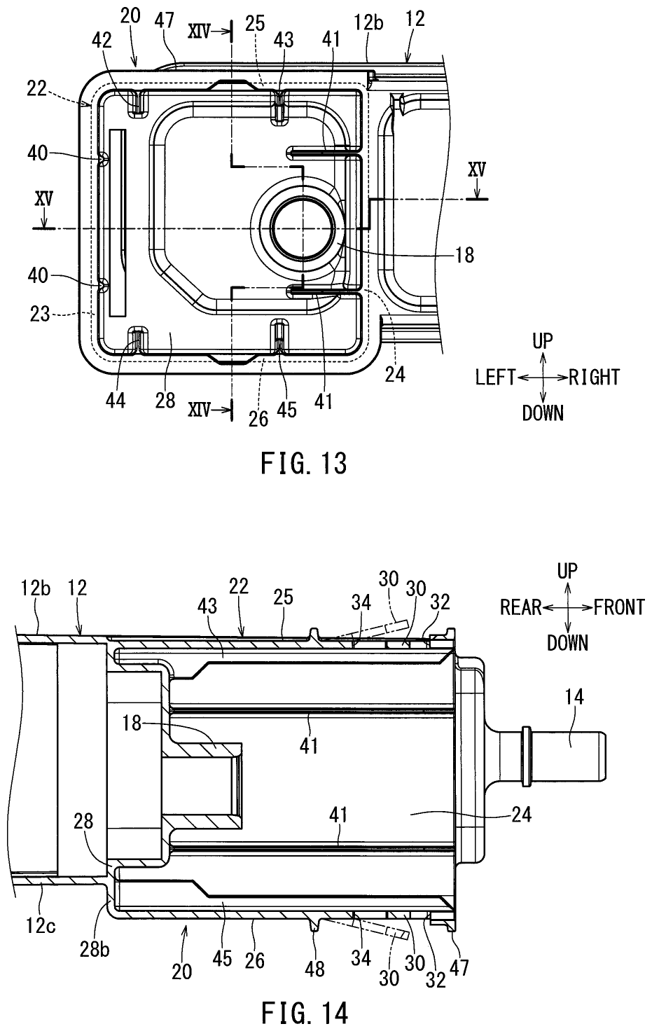

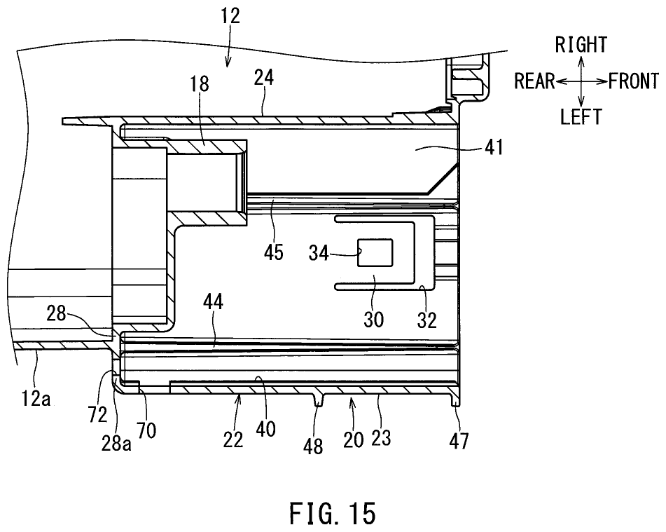

FIG. 13 is a front view of the pump mounting portion 20 of the canister 10. FIG. 14 is a cross-sectional view taken along line XIV-XIV of FIG. 13. FIG. 15 is a cross-sectional view taken along line XV-XV of FIG. 13. As shown in FIG. 14, the pump mounting portion 20 includes a corner wall portion 22 with a square tubular shape. The pump mounting portion 20 also includes a rear wall 28 that closes the rear end surface of the corner wall portion 22 (see FIG. 15). The rear wall 28 also serves as a partition wall that partitions the internal space of the corner wall portion 22 and the internal space of the canister case 12 in front and rear direction.

As shown in FIG. 13, the purge port 18 is disposed at a position right of the central portion of the rear wall 28. The purge port 18 has a stepped cylindrical shape protruding forward from the rear wall 28 (see FIGS. 14 and 15). The suction port 56 of the purge pump 50 connects to the purge port 18 by insertion (see FIGS. 3 and 4).

As shown in FIG. 13, the corner wall portion 22 may have a left side wall 23, a right side wall 24, an upper side wall 25, and a lower side wall 26. The pump mounting portion 20 may also be referred to herein as a “component mounting portion.” The right side wall 24 also serves as a partition wall that partitions the internal space of the corner wall portion 22 and the internal space of the canister case 12 in right and left direction (see FIG. 15). The upper side wall 25 is formed so as to be substantially in the same plane as an upper wall 12b of the canister case 12 (see FIG. 6). The left side wall 23, the right side wall 24, the upper side wall 25, and the lower side wall 26 may also be referred to herein as the “side wall.”

As shown in FIG. 15, the left side wall 23 of the corner wall portion 22 is disposed at a position shifted more leftward than a left side wall 12a of the canister case 12. Consequently, the left end 28a of the rear wall 28 extends leftward and is exposed to the outside (see FIG. 5). As shown in FIG. 14, the lower side wall 26 of the corner wall portion 22 is disposed at a position shifted more downward than a lower wall 12c of the canister case 12. Consequently, the lower end 28b of the rear wall 28 extends downward and is exposed to the outside (see FIG. 5). The left side wall 23, the upper side wall 25, the lower side wall 26, the left end 28a of the rear wall 28, and the lower end 28b of the rear wall 28 may also be referred to herein as the “wall exposed to the outside.”

As shown in FIG. 6, an elastic engaging piece 30, which has a strip-plate shape, is positioned at the front end of the center, in the left-right direction, of the upper side wall 25. The elastic engaging piece 30 is formed by a U-shaped cutout opening 32 in the upper side wall 25, so as to surround the elastic engaging piece 30. As a result, the front end of the elastic engaging piece 30 has a fixed end and a free end. The elastic engaging piece 30 is configured to be elastically deformed in the vertical direction (see the two-dot chain line 30 in FIG. 14). An engaging hole 34, which has a square shape is formed in the center of the elastic engaging piece 30.

Another elastic engaging piece 30 (the same reference number), which is opposed and symmetrical with the elastic engaging piece 30 of the upper side wall 25 in the up-and-down direction, is formed on the lower side wall 26. Engaging holes 34 of the elastic engaging pieces 30 are positioned such that both engagement projections 68 of the purge pump 50 simultaneously engages holes 34 when the purge pump 50 is sufficiently inserted into the pump mounting portion 20 is completed (see FIG. 3).

As shown in FIG. 13, upper and lower left projections 40, which are parallel to each other, extends from the inner surfaces of the left side wall 23. Upper and lower right projections 41, which are parallel to each other, extend from the inner surface of the right side wall 24. Both left projections 40 and both right projections 41 may be disposed so as to face each other.

An upper left projection 42 and an upper right projection 43, which are parallel to each other, extend from the inner surface of the upper side wall 25. A lower left projection 44 and a lower right projection 45, which are parallel to each other, extend from the inner surface of the lower side wall 26. The upper left projection 42 and the lower left projection 44 are disposed opposite to each other. The upper right projection 43 and the lower right projection 45 are disposed opposite to each other. The left projections 40, the right projections 41, the upper left projection 42, the upper right projection 43, the lower left projection 44, and the lower right projection 45 each has a linear and rib shape. These projections 40-45 also extend in the axial direction of the corner wall portion 22, that is, in the front-rear direction. The left projections 40, the right projections 41, the upper left projection 42, the upper right projection 43, the lower left projection 44, and the lower right projection 45 may each also be referred to herein as the “supporting projection.”

As shown in FIG. 6, a reinforcing flange or rib 47 extends over the entire circumference of the outer peripheral portion of the open end of the corner wall portion 22. The reinforcing rib 47 may also be referred to herein as a “first reinforcing rill” A reinforcing flange or rib 48 is provided at the center of the corner wall portion 22 in the front-rear direction. The reinforcing rib 48 extend over the outer periphery of the left side wall 23, the upper side wall 25, and the lower side wall 26 and has a general C-shape. The reinforcing rib 48 is positioned so as to cross the vicinity of the rear of both the elastic engaging pieces 30. The reinforcing rib 48 may also be referred to herein as a “second reinforcing rib.” The second reinforcing rib 48 extends over the entire circumference of the corner wall portion 22.

A communication slot or hole 70 extends through the rear end of the left side wall 23. The communication hole 70 has a long narrow shape oriented in the up-down direction. The communication hole 70 penetrates the left side wall 23 in the wall thickness direction, that is, the left-right direction (see FIG. 15). The communication hole 70 may also be referred to herein as a “first communication hole.”

As shown in FIG. 5, a communication slot or hole 72 extends through the left end 28a of the rear wall 28. The communication hole 72 has a long narrow shape oriented in the up-down direction. The communication hole 72 penetrates the rear wall 28 in the wall thickness direction, that is, the front-rear direction (see FIG. 15). The communication hole 72 may also be referred to herein as a “second communication hole.”

As shown in FIG. 6, the purge pump 50 is inserted into the pump mounting portion 20 of the canister 10 from the front (specifically, by press-fitting in this embodiment). The purge pump 50 is inserted with the suction port 56 facing backward and the motor housing 62 facing left.

In the process of inserting the purge pump 50 into the pump mounting portion 20, the left end surface 62a of the motor housing 62 of the purge pump 50 is in sliding contact with both the left projections 40 of the corner wall portion 22. The upper and lower ends of the outer peripheral surface 62b of the motor housing 62 are in sliding contact with the upper left projection 42 and the lower left projection 44 of the corner wall portion 22. Further, the right end surface 54a of the pump housing 54 of the purge pump 50 is in sliding contact with both right projections 41 of the corner wall portion 22. The upper end of the outer peripheral surface 54b of the pump housing 54 is in sliding contact with the upper right projection 43 of the corner wall portion 22. The lower surface 54d of the pump housing 54 is in sliding contact with the lower right projection 45 of the corner wall portion 22. As a result, the purge pump 50 is positioned by press fitting and is positioned with respect to the radial direction of the corner wall portion 22. In addition, the suction port 56 is disposed concentrically with and oppositely to the purge port 18.

Further, when the purge pump 50 is pushed in, the suction port 56 is simultaneously inserted into the purge port 18 to complete the connection (see FIGS. 2 to 4). Both elastic engaging pieces 30 of the corner wall portion 22 are bent and elastically deformed in the expanding direction by both engagement projections 68 of the purge pump 50. Thereafter, both elastic engaging pieces 30 are elastically restored simultaneously or substantially simultaneously with the completion of the connection of the suction port 56 with the purge port 18. Thus, both engaging holes 34 are engaged with both engagement projections 68 (see FIG. 3). As a result, the purge pump 50 is prevented from disengaging the pump mounting portion 20, thereby mounting of the purge pump 50 to the canister 10 by snap-fitting (see FIG. 1).

The purge pump 50 is supported in the internal space of the corner wall portion 22 with a predetermined gap therebetween. This gap is maintained by the left projections 40, the right projections 41, the upper left projection 42, the upper right projection 43, the lower left projection 44, and the lower right projection 45 of the pump mounting portion 20 (see FIG. 2). Thus, a gap passage 75, which communicates the front end opening of the pump mounting portion 20 with the rear wall 28 of the pump mounting portion 20, is provided between the corner wall portion 22 of the pump mounting portion 20 and the purge pump 50 (see FIGS. 2 to 4).

The rear end of the gap passage 75 is in fluid communication with the outside air via the first communication hole 70 and the second communication hole 72 of the pump mounting portion 20 (see FIG. 4). As previously described, the gap passage 75 extends between the corner wall portion 22 of the pump mounting portion 20 and the purge pump 50. A predetermined distance may be set between the rear wall 28 of the pump mounting portion 20 and the front side, excluding the suction port 56, of the purge pump 50 (see FIG. 4).

The purge pump 50 is positioned so that the motor housing 62 of the motor unit 60 faces the left side wall 23 of the pump mounting portion 20. The motor housing 62 is disposed in the portion of the gap passage 75 that extends substantially linearly from the front end opening toward the first communication hole 70 and the second communication hole 72. The purge pump 50 is positioned so that the pump housing 54 of the pump unit 52 faces the right side wall 24 of the pump mounting portion 20.

The canister 10, to which the purge pump 50 is mounted (see FIG. 1), may be attached to a rigid structure, such as a frame of a vehicle. Therefore, when a vehicle is traveling, the air introduced to the pump mounting portion 20 of the canister 10 via the opening thereof passes through the gap passage 75. The air is then discharged to the outside via the first communication hole 70 and the second communication hole 72. As a result, heat accumulated in the gap passage 75 is dissipated.

According to the accessory component mounting structure of the present embodiment, the gap passage 75 in fluid communication with the outside via the first communication hole 70 and the second communication hole 72 is provided between the pump mounting portion 20 and the purge pump 50. Accordingly, air can pass through the gap passage 75, thereby dissipating heat accumulated in the gap passage 75 and preventing the heat generated by the motor unit 60 of the purge pump 50 from accumulating in the internal space of the pump mounting portion 20 of the canister 10. Consequently, deterioration of the purge pump 50 due to a rise in temperature of the purge pump 50 may be reduced and/or avoided. Further, moisture that may have entered the gap passage 75 may be discharged to the outside together with the air introduced into the gap passage 75.

Since the left projections 40, the right projections 41, the upper left projection 42, the upper right projection 43, the lower left projection 44, and the lower right projection 45 provided on the pump mounting portion 20 abut the purge pump 50, rattling of the purge pump 50 is suppressed. At the same time, it is possible to form the gap passage 75. By suppressing the rattling of the purge pump 50, it is possible to suppress the vibration of the purge pump 50 and the wear of the contact portion between each of the projections 40 to 45 and the purge pump 50. Since the projections 40 to 45 aid in the formation of the gap passage 75 and the support of the purge pump 50, the configuration may be simplified in the present embodiment.

The left projections 40, the right projections 41, the upper left projection 42, the upper right projection 43, the lower left projection 44, and the lower right projection 45 are provided on the pump mounting portion 20. Therefore, compared with the case where the projections 40 to 45 are formed on the purge pump 50, the dimensions of the projections 40 to 45 may be more easily controlled, and the support position of the purge pump 50 may be more easily managed. Further, it is possible to prevent the heat generated by the motor unit 60 of the purge pump 50 from accumulating in the internal space of the pump mounting portion 20 of the canister 10. Moreover, this may be done without requiring a design change of the purge pump 50.

The purge pump 50 is held by the projecting ends of the projections 40 to 45. Accordingly, the degree of rattling of the purge pump 50 may be easily adjusted and controlled by the extension amount of the projections 40 to 45, as compared with the case where the purge pump 50 is held in a surface contact by the inner surface of the corner wall portion 22.

The first communication hole 70 is formed at the left side wall 23 of the pump mounting portion 20, which is exposed to the outside. The second communication hole 72 is formed at the left end 28a of the rear wall 28 of the pump mounting portion 20, which is exposed to the outside. Therefore, the air permeability of the gap passage 75 may be improved.

The purge pump 50 is disposed such that the motor unit 60 faces the left side wall 23 of the pump mounting portion 20, which is exposed to the outside. Therefore, it is possible to suppress heat from accumulating on the right side wall 24 as compared with the case where the motor unit 60 of the purge pump 50 faces the right side wall 24 of the pump mounting portion 20, which is not exposed to the outside. As a result, the resin deterioration of the right side wall 24 may be suppressed.

Since the motor unit 60 of the purge pump 50 is exposed to the gap passage 75, the cooling efficiency of the motor unit 60 may be improved by the air passing through the gap passage 75. Since the motor unit 60 is disposed in the portion of the passage that extends substantially linearly from the front end opening of the gap passage 75 toward the first communication hole 70 and the second communication hole 72, the cooling efficiency of the motor unit 60 may be further improved.

The rigidity of the pump mounting portion 20 may be improved by the first reinforcing rib 47, which is formed on the outer peripheral of the opening end of the corner wall portion 22 of the pump mounting portion 20.

The rigidity of the pump mounting portion 20 may be improved by the second reinforcing rib 48 formed on the outer peripheral of the central portion, in the front-rear direction, of the corner wall portion 22 of the pump mounting portion 20.

Since the heat dissipation area of the pump mounting portion 20 is increased by the first reinforcing rib 47 and the second reinforcing rib 48, heat dissipation of the internal space of the pump mounting portion 20 may be promoted.

The above is a description of an embodiment of the technology disclosed herein. However, the technology may be implemented in various other forms. For example, in the above embodiment, the purge pump 50 is exemplified as an accessory component. However, an On-Board Diagnosis (OBD) pump used for a leakage test of the canister 10 performed when the engine of the vehicle is stopped or any other component may be used as the accessory component.

In the above embodiment, the gap passage 75 is formed by providing support projections on the pump mounting portion 20. However, the gap passage 75 may alternatively be formed by providing support projections on the purge pump 50. Further, the gap passage 75 may alternatively be formed by providing support protrusions on both the pump mounting portion 20 and the purge pump 50. The rib-shaped support protrusion may be one or more. The support projection is not limited to a rib-shape and may be changed to an arbitrary shape as long as the support projection forms a gap passage.

For example, the number, shape, and position of the communication hole may be changed as appropriate. For example, one of the first communication hole 70 and the second communication hole 72 may be omitted. The number of the first communication hole 70 and/or the second communication hole 72 may be increased (e.g., more than one first communication hole 70 and/or more than one second communication hole 72 may be provided). A communication hole may be formed at a lower end 28b of the rear wall 28. In the above embodiment, the front end opening of the pump mounting portion 20 is used as an air inlet, and the first communication hole 70 and the second communication hole 72 are used as air outlets. Alternatively, the first communication hole 70 and the second communication hole 72 of the pump mounting portion 20 may be used as inlets, and the front end opening may be used as an outlet.

The first reinforcing rib 47 may be omitted. The number of the second reinforcing ribs 48 may be increased or may be omitted. The reinforcing rib may be formed on an outer peripheral of the component mounting portion, or may also be formed on an inner periphery thereof. In addition, the reinforcing ribs may be formed continuously in the circumferential direction of the component mounting portion, or may be formed intermittently in the circumferential direction.

The various examples described above in detail with reference to the attached drawings are intended to be representative of the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved accessory component mounting structure for a canister, and/or methods of making and using the same.

Techniques are disclosed in various aspects in the present disclosure. A first embodiment is an accessory component mounting structure for a canister including a tubular component mounting portion provided in the canister and an accessory component having a heat-generating portion that generates heat. The accessory component is inserted into the internal space of the component mounting portion and is mounted by snap-fitting. A gap passage communicating an opening side of the component mounting portion with the rear side thereof is formed between the component mounting portion and the accessory component. A communication hole providing fluid communication between the gap passage and the outside is formed in the component mounting portion.

According to the first embodiment, the gap passage communicating with the outside via the communication hole is formed between the component mounting portion and the accessory component. Therefore, air may pass through the gap passage and the heat accumulated in the gap passage may be dissipated. As a result, it is possible to suppress the heat generated by the heat-generating portion of the accessory component from accumulating in the internal space of the component mounting portion of the canister.

A second embodiment is the accessory component mounting structure for the canister according to the first embodiment, wherein the component mounting portion is provided with a support projection. The support projection abuts the accessory component and forms a gap. The gap serves as the gap passage.

According to the second embodiment, since the support projection provided on the component mounting portion abuts the accessory component, it is possible to form a gap that serves as the gap passage while also suppressing the rattling of the accessory component. Since the support projection is formed on the component mounting portion, compared with the case where the support projection is formed on the accessary component, the dimensions of the support projection may be easily controlled and the support position of the accessory component may be easily managed. Further, it is possible to prevent the heat generated by the heat-generating portion of the accessory component from accumulating in the internal space of the component mounting portion of the canister. This may be done without requiring a design change in the accessary component.

A third embodiment is the accessory component mounting structure for the canister according to the first embodiment or the second embodiment, wherein the communication holes are formed at a side wall and a rear wall of the component mounting portion, wherein the side and rear walls are exposed to the outside.

According to the third embodiment, since the communication holes are formed at a side wall and a rear wall of the component mounting portion, with the walls being exposed to the outside, the air permeability of the gap passage may be improved.

A fourth embodiment is the accessory component mounting structure for the canister according to any one of the first to third embodiment, wherein the accessory component is disposed such that the heat-generating portion faces the side wall of the component mounting portion, the side wall being exposed to the outside.

According to the fourth embodiment, it is possible to suppress heat from accumulating on the wall of the component mounting portion that is not exposed to the outside, as compared with the case where the heat-generating portion of the accessory component faces the wall of the component mounting portion that is not exposed to the outside.

A fifth embodiment is the accessory component mounting structure for the canister according to any one of the first to fourth embodiment, wherein the heat-generating portion of the accessory component is exposed to the gap passage.

According to the fifth embodiment, since the heat-generating portion of the accessory component is exposed to the gap passage, the cooling efficiency of the heat-generating portion may be improved by the air passing through the gap passage.

A sixth embodiment is the accessory component mounting structure for the canister according to any one of the first to fifth embodiment, wherein a reinforcing rib, which extends in the circumferential direction is formed on the component mounting portion.

According to the sixth embodiment, the rigidity of the component mounting portion may be improved by the reinforcing rib, which is formed on the component mounting portion. Since the heat dissipation area of the component mounting portion is increased by the reinforcing rib, heat dissipation of the internal space of the component mounting portion may be promoted.

1. An accessory component mounting structure for a canister, the accessory component mounting structure comprising:
a tubular component mounting portion provided in the canister; and
an accessory component including a heat-generating portion configured to generate heat, wherein:
the accessory component is positioned in an internal space of the component mounting portion and is mounted therein by a snap-fitting;
a gap passage in fluid communication with an opening side of the component mounting portion and a rear side of the component mounting portion, wherein the gap passage is positioned between the component mounting portion and the accessory component; and
a communication hole in the component mounting portion, wherein the communication hole is in fluid communication with the gap passage and the outside.

2. The accessory component mounting structure of claim 1, wherein the component mounting portion includes a support projection that abuts the accessory component and is configured to form a gap that defines the gap passage.

3. The accessory component mounting structure of claim 1, wherein:
the communication hole is formed in a side wall of the component mounting portion;
a second communication hole is formed in a rear wall of the component mounting portion; and
the side wall and the rear wall of the component mounting portion are exposed to the outside.

4. The accessory component mounting structure of claim 1, wherein the accessory component is positioned such that the heat-generating portion faces a side wall of the component mounting portion that is exposed to the outside.

5. The accessory component mounting structure of claim 1, wherein the heat-generating portion of the accessory component is exposed to the gap passage.

6. The accessory component mounting structure of claim 1, wherein:
a reinforcing rib is formed on the component mounting portion; and
the reinforcing rib extends in the circumferential direction about the component mounting portion.

7. The accessory component mounting structure of claim 1, wherein the gap passage traverses the heat-generating portion of the accessory component within the component mounting portion.

8. The accessory component mounting structure of claim 1, wherein the gap passage traverses the heat-generating portion of the accessory component within the component mounting portion along the shortest path between the opening side of the component mounting portion and the rear side of the component mounting portion.

9. The accessory component mounting structure of claim 1, wherein the gap passage is configured to allow sufficient airflow to cause heat generated in the component mounting portion to be dissipated and/or to cool the heat-generating portion of the accessory component.

10. The accessory component mounting structure of claim 1, wherein the component mounting portion includes a front end in a front-rear direction and a rear end opposite to the front end, wherein the opening side of the component mounting portion is disposed at the front end and the rear side of the component mounting portion is disposed at the rear end.
